(19) United States
(12) Patent Application Publication
(10) Pub. No.: US 2008/0190371 A1
(43) Pub. Date: Aug. 14, 2008

(54) Apparatus for hanging a bird feeder

(76) Inventor: Stewart C. Gardner, Mansfield, MA (US)

Correspondence Address: Steven S. Payne, P.O. Box 65024, Washington, DC, 20035, US

(21) Appl. No.: 11/704,883

(22) Filed: Feb. 9, 2007

(51) Int. Cl. A01K 39/04

(52) U.S. Cl. 119/61.3; 119/72

(57) ABSTRACT

An apparatus for hanging a bird feeder with a liquid reservoir is disclosed. The apparatus comprises: a shell divided vertically into two halves from top to bottom. A hinge is connected to at least a portion of a first edge of each shell half to allow the shell to open and close. At least one fastening mechanism is connected near a second edge of each shell half for fastening the two shell halves together, wherein an interior space is created when the two shell halves are closed to surround the liquid reservoir of the feeder. A substantially semi-circular opening is provided on the bottom of each shell half at least partially filled with a compressible material, wherein the substantially semi-circular openings create a substantially circular opening when the shell is closed. A hanging device is provided on the top of the shell.

### FIELD OF THE INVENTION

The present invention relates generally to bird feeders. More particularly, the present invention relates to an apparatus for hanging a hummingbird feeder which protects at least part of the hummingbird feeder from sunshine.

### BACKGROUND OF THE INVENTION

Millions of people around the world enjoy watching and feeding wild birds. These people love to feed the wild birds in their backyards or on their balconies so that they can enjoy watching the birds. While there are many types of wild birds that people like to watch and feed, the hummingbird is a favorite for many people. Hummingbirds are attracted to sweet nectar produced by flowers. As a substitute for the sweet nectar, people use water sweetened by sugar in hummingbird feeders to attract and feed the hummingbirds.

A typical hummingbird feeder is comprised of a fluid reservoir for holding the sugar water which is conveyed to a plurality of simulated flowers. The hummingbirds insert their long thin beak into holes in the simulated flowers to drink the sugar water. While the sugar water is an effective substitute for natural flower nectar, the use of sweetened water has several drawbacks.

It is generally known that warm weather and direct sunlight accelerate the rate at which sweetened water (nectar) will spoil and ferment which can quickly lead to the production of bacteria, mold and mildew. The bacteria, mold and mildew will discolor the sweetened water and may begin to grow inside the fluid reservoir. As a result, the hummingbird feeder can quickly turn into an unsightly mess. In addition, the bacteria, mold and mildew can also be harmful and fatal to the hummingbirds. As a result, hummingbird feeders must be cleaned on a regular basis, for example, every three or four days. The constant hassle of cleaning the hummingbird feeder has caused many people to stop using their hummingbird feeders.

Thus, there is a need for an apparatus for hanging a new hummingbird feeder which overcomes the problems cited above.

### SUMMARY OF THE INVENTION

It is therefore a feature and advantage of the present invention to provide an apparatus for hanging a hummingbird feeder which protects the nectar in the hummingbird feeder from sunlight while also helping to cool the nectar.

According to one aspect of the invention, a protective shell is provided to hold and shield a hummingbird feeder with a liquid reservoir from sunlight.

In accordance with one embodiment of the present invention, an apparatus for hanging a bird feeder with a liquid reservoir is disclosed. The apparatus comprises: a shell divided vertically into two halves from top to bottom; a hinge connected to at least a portion of a first edge of each shell half to allow the shell to open and close; at least one fastening mechanism connected near a second edge of each shell half for fastening the two shell halves together, wherein an interior space is created when the two shell halves are closed to surround the liquid reservoir of the feeder; a substantially semi-circular opening on the bottom of each shell half at least partially filled with a compressible material, wherein the substantially semi-circular openings create a substantially circular opening when the shell is closed; and a hanging device on the top of said shell.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The invention will now be described, by way of example, with reference to the accompanying drawings, wherein:

FIG. 1 illustrates a side view of a hanging apparatus with a shell in an open position according to one embodiment of the invention;

FIG. 2 illustrates a bottom view of the hanging apparatus illustrated in FIG. 1 according to one embodiment of the invention;

FIG. 3 illustrates a bottom view of the hanging apparatus with the shell in a closed position according to one embodiment of the invention;

FIG. 4 illustrates a side view of a hanging apparatus with the shell in the closed position according to another embodiment of the invention; and

FIG. 5 illustrates a side view of a hanging apparatus holding a hummingbird feeder according to another embodiment of the invention.

### DETAILED DESCRIPTION OF PREFERRED EMBODIMENTS OF THE INVENTION

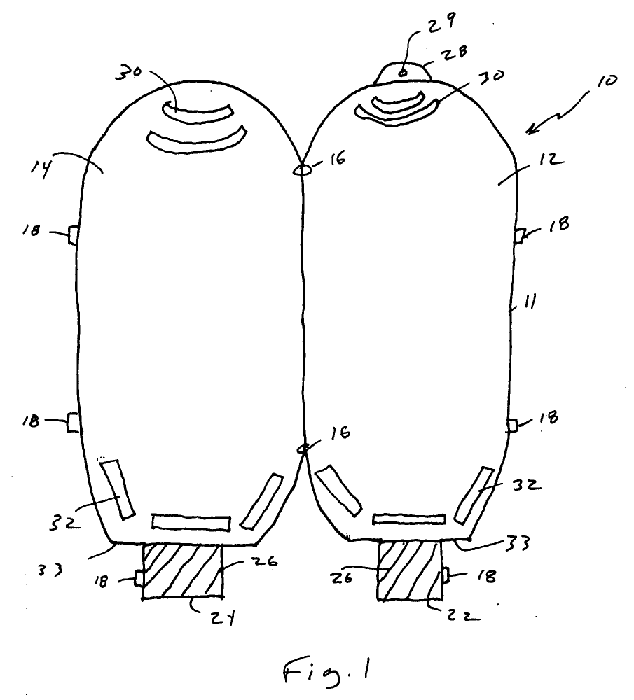

FIG. 1 illustrates a side view of a hanging apparatus 10 for hanging a hummingbird feeder according to one embodiment of the invention. The hanging apparatus 10 is comprised of a shell structure 11 which has a first half 12 and a second half 14. The two shell halves 12, 14 are connected together along at least a portion of one edge of each shell half by a hinge 16. The hinge 16 allows the shell 11 to open and close so that a hummingbird feeder can be removably placed within the shell 11. When in the closed position, the two shell halves 12, 14 may be secured by at least one fastening mechanism 18 located on or near the edges of the shell halves opposite the hinge 16. The fastening mechanism(s) 18 can be of various types of fastening means, for example, plastic snaps, tabs and indentions for receiving the tabs, buckles, VELCRO®, etc., and the invention is not limited thereto.

In this embodiment, the shell 11 has a plurality of open slots/vents/louvers 30, 32 at the top and bottom of the shell 11. The slots/vents/louvers 30, 32 allow hot air inside the shell 11 to exit through the top of the shell 11 while cooler ambient air is drawn into the interior of the shell 11 through the openings in the bottom of the shell 11.

The shell 11 is preferably made of a plastic material. According to one embodiment of the invention, the shell 11 is made of an opaque plastic material. The opaque plastic material prevents some or all of the sunlight striking the shell 11 from penetrating into the interior of the shell 11. Thus, when a liquid feeder is placed inside the shell 11, the liquid will be protected from sunlight, thereby decreasing the rate at which the liquid will spoil. According to one embodiment of the invention, the opaque plastic material is brightly colored using one or more colors, such as red, so as to help attract hummingbirds to the feeder but the invention is not limited thereto.

According to another embodiment of the invention, the plastic shell 11 is made of a clear plastic material. In this embodiment, an opaque material is either attached inside or outside the shell 11 to block the sunlight from penetrating through to the interior of the shell 11. The opaque material may be a plastic film or some other material and the invention is not limited thereto.

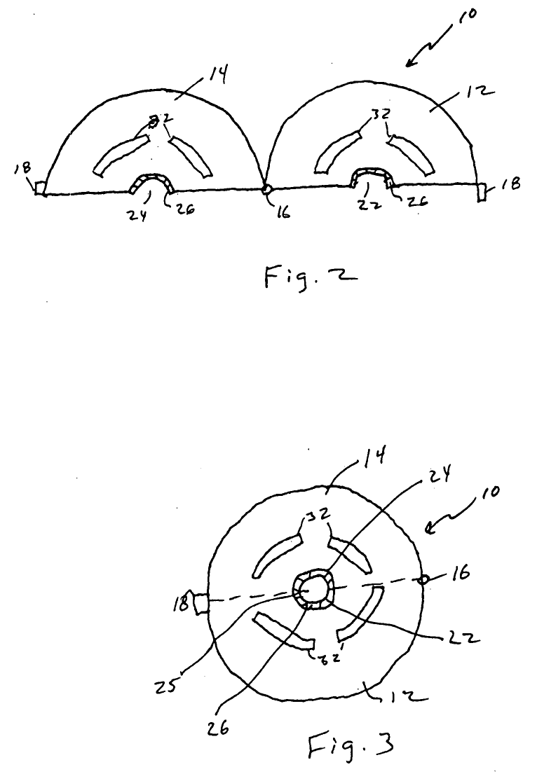

Each shell half 12, 14 has an opening 22, 24 at the bottom of the shell half. As illustrated in FIGS. 2-3, the openings 22, 24 have a substantially semi-circular shape. As a result, when the shell 11 is closed, the openings 22, 24 create substantially circular opening 25 in the bottom of the shell 11. The inside of the opening 22, 24 is at least partially lined with a compressible material 26. The compressible material 26 is comprised of a compressible foam, rubber, etc., and the invention is not limited thereto. As will be explained in more detail below with reference to FIG. 5, a portion of a hummingbird feeder extends out from the interior of the shell 11 through the opening 25. The compressible material 26 surrounds a portion of the hummingbird feeder and holds the feeder in place when the shell 11 is closed.

The hanging apparatus 10 also has a hanging device 28 on the top of the shell 11. The hanging device 28 may be a hook, loop, or a protrusion on the shell 11 with a hole 29 for receiving a hook, string, chain, etc., for hanging the apparatus 10.

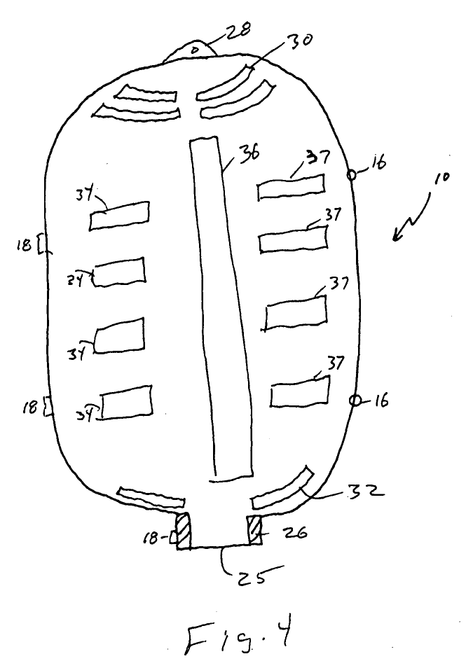

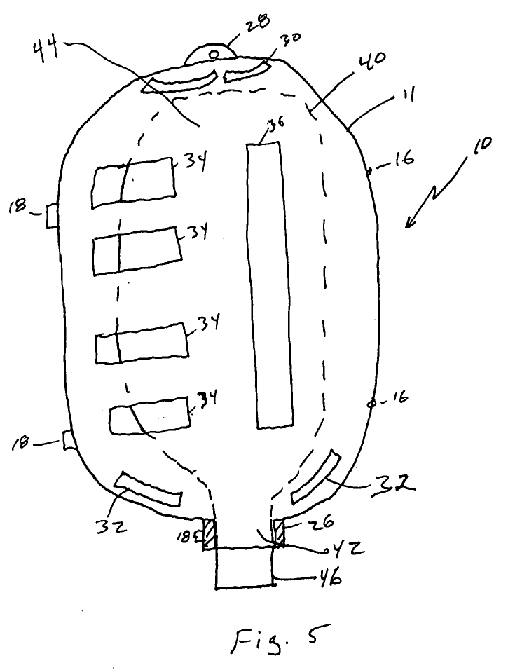

The shell 11 may have various shapes and sizes, e.g. circular, oval, oblong, a simulated group of flowers, etc., so long as the shell 11 has an open interior for storing a fluid reservoir of a feeder and a opening which allows a portion of a feeder to protrude out from the bottom of the shell 11. According to one embodiment of the invention, the shell 11 has a shape similar to a large bottle as illustrated in FIG. 1 but the invention is not limited thereto. As mentioned above, the shell 11 can have various shapes. For example, the sides of the shell 11 may curve or taper down to the opening 22, 24 as illustrated in FIGS. 4-5 or may curve or taper down to a substantially flat section 33 prior to reaching the openings 22, 24 as illustrated in FIG. 1 and the invention is not limited thereto.

According to another embodiment of the invention, the shell 11 may have additional slots/vents/louvers 34, 36 between the top and the bottom of the shell 11 as illustrated in FIG. 4. The slots/vents/louvers may run horizontal 34 or vertical 36. In addition to providing extra ventilation, these slots/vents/louvers 34, 36 also allow a user to look inside the plastic shell 11. According to one embodiment of the invention, the slots/vents/louvers 34, 36 are arranged so that slots/vents/louvers are arranged on opposite sides of the shell 11 so that the user can see through the shell 11. This feature is important when a feeder is inserted into the interior of the shell 11. The slots/vents/louvers 34, 36 allow a user to view the feeder with out having to open the feeder to determine the amount of fluid remaining in the feeder as well as to determine whether the liquid has spoiled. In an alternative embodiment, clear windows 37 can be provided in the opaque plastic material or opaque covering so as to allow the user to see into the shell 11.

FIG. 5 illustrates a hanging apparatus 10 containing a feeder 40 according to one embodiment of the invention. The feeder 40 has a fluid reservoir 44, a neck 42 and a mouth 46. The feeder 40 can be shaped like a bottle but the invention is not limited thereto. As shown in FIG. 5, a portion of the neck 42 is tightly secured by the compressible material 26 when the shell 11 is closed so as to keep the feeder 40 in a proper position within the shell 11. According to one embodiment of the invention, the interior of the shell 11 does not touch the feeder 40 but the invention is not limited thereto. This allows for better air circulation around the feeder in the shell 11. The mouth of the feeder 46 extends out from the hanging apparatus 10 and can be attached to more components of a hummingbird feeder which are used to allow hummingbirds to drink the nectar stored in the fluid reservoir 44. It will be understood by those skilled in the art that the invention can be used with many different types of hummingbird feeders with different shapes and sizes, as long as the body of the feeder can be enclosed within the shell 11 and a neck and mouth portion can fit through the opening 25. One such feeder is disclosed in U.S. patent application Ser. No. ______, entitled “A Bottle Cap for a Bird Feeder” which is being filed concurrently herewith and is incorporated herein by reference.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for hanging a bird feeder with a liquid reservoir, comprising:
a shell divided vertically into two halves from top to bottom;
a hinge connected to at least a portion of a first edge of each shell half to allow the shell to open and close;
at least one fastening mechanism connected near a second edge of each shell half for fastening the two shell halves together, wherein an interior space is created when the two shell halves are closed to surround the liquid reservoir of the feeder;
a substantially semi-circular opening on the bottom of each shell half at least partially filled with a compressible material, wherein the substantially semi-circular openings create a substantially circular opening when the shell is closed; and
a hanging device on the top of said shell.

2. The apparatus according to claim 1, wherein open slots are provided in the shell near the top and bottom of the shell.

3. The apparatus according to claim 1, wherein at least one open slot is provided in the shell between the top and bottom of the shell.

4. The apparatus according to claim 3, wherein the at least one slot comprises a vertical slot.

5. The apparatus according to claim 4, wherein the at least one open slot comprises horizontal slots.

6. The apparatus according to claim 1, wherein at least one window is provided in the shell so as to allow a portion of the interior of the shell to be viewed through the shell.

7. The apparatus according to claim 1, wherein the shell is made of a plastic material.

8. The apparatus according to claim 7, wherein the plastic material is opaque so as to block sunlight from penetrating through the plastic material.

9. The apparatus according to claim 7, wherein the plastic material is brightly colored.

10. The apparatus according to claim 1, wherein the shell is shaped substantially like a bottle.

11. The apparatus according to claim 1, wherein a bottle shaped bird feeder may be stored within the interior of the space of the shell.

12. The apparatus according to claim 1, wherein only the compressible material touches part of the bird feeder when the bird feeder is stored in the interior space of the shell.

13. The apparatus according to claim 1, wherein the compressible material is comprised of a compressible foam or rubber.

14. The apparatus according to claim 1, wherein the hanging device is a hook or loop.

15. The apparatus according to claim 1, wherein the hanging device is a protrusion on the top of the shell with a hole therein.
